(19) United States
(12) Patent Application Publication
(10) Pub. No.: US 2002/0074082 A1
(43) Pub. Date: Jun. 20, 2002

(54) Fabrication method for an electrostatographic member having a virtual flexible seamless substrate (subtantially seamless electrostatographic member fabrication method with interlock)

(75) Inventors: Robert C.U. Yu, Webster, NY (US); Anthony M. Horgan, Pittsford, NY (US); Satchidanand Mishra, Webster, NY (US); Donald C. Von Hoene, Fairport, NY (US); Bing R. Hsieh, San Jose, CA (US); Edward F. Grabowski, Webster, NY (US); Richard L. Post, Penfield, NY (US); Kathleen M. Carmichael, Williamson, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation, Stamford, CT (US)

(21) Appl. No.: 09/683,329

(22) Filed: Dec. 14, 2001

Related U.S. Application Data
(60) Provisional application No. 60/256,154, filed on Dec. 15, 2000.

(51) Int. Cl. G03G 15/24

(52) U.S. Cl. 156/256; 399/152; 156/304.5

(57) ABSTRACT

A seamless flexible electrostatographic imaging member belt fabrication method comprising providing a flexible substrate support sheet, such as with a rectangular shape, placing a template on the support sheet, producing first desired features on a first portion of the substrate support sheet, including removing material from the substrate support sheet with first emissions, producing second desired features on a second portion of the substrate support sheet complementary to the first desired features, including removing material from the substrate support sheet with second emissions, overlapping the first and second desired features, bonding the first desired pattern with the second desired pattern to produce a seamed substrate support belt having substantially no added seam thickness and applying at least one coating over the substrate support belt.

### CROSS REFERENCE TO RELATED APPLICATIONS

This application is based on a Provisional Patent Application No. 60/256,154, filed Dec. 15, 2000. In addition, this application is related to U.S. patent applications Nos. 09/683,326 and ______ filed with this application on Dec. 14, 2001.

### BACKGROUND OF INVENTION

This invention relates in general to flexible belts, and more specifically, to a fabrication method for electrostatographic members having single layer substrate support belts.

Typical flexible belts used for different kinds of practical application are, generally, prepared in either a seamed or a seamless belt configuration. These flexible belts are commonly utilized to suit numerous functioning purposes such as electrostatographic imaging member belts, conveyor belts, drive belts, intermediate image transfer belts, sheet transport belts, document handling belts, donor belts for transporting toner particles, motor driving belts, torque assist driven belts, and the like.

Although the scope of the present invention concept covers all the above-mentioned flexible belts, nonetheless for simplicity reason, the discussion herein after will focus and be represented only by electrostatographic imaging member belts and intermediate image transfer belts.

Flexible belts, such as electrostatographic imaging member belts, are well known in the art. Typical electrostatographic flexible imaging members include, for example, photoreceptors for electrophotographic imaging systems, and electroreceptors or ionographic imaging members for electrographic imaging systems. Both electrophotographic and electrographic imaging member belts are commonly utilized in a seamed belt configuration based from ease of belt fabrication and cost considerations, even though seamless imaging belts are preferred since the whole belt surface is a viable imaging area. Typical seamed electrostatographic imaging member belts commonly employed in imaging machines have a welded seam formed from ultrasonic welding process.

For electrophotographic applications, the flexible electrophotographic imaging member or photoreceptor belts preferably comprise a flexible substrate support coated with one or more layers of photoconductive material. The substrate supports are usually organic materials such as a film forming thermoplastic polymer. The photoconductive coatings applied to these substrates may comprise inorganic materials such as selenium or selenium alloys, organic materials, or combinations of organic and inorganic materials. The organic photoconductive layers may comprise, for example, a single binder layer having dissolved or dispersed therein a photosensitive material or multilayers comprising, for example, a charge generating layer and a charge transport layer. The charge generating layer is capable of photogenerating holes and injecting the photogenerated holes into the charge transport layer.

The flexible electrographic imaging or ionographic belts though analogous to photoreceptor belts are, however, of simpler material design; these belts, in general, comprise either a flexible single layer conductive substrate support or an insulating substrate support having a conductive metallic surface and overcoated on with a dielectric imaging layer. The basic process for using electrostatographic flexible imaging member belts is well known in the art.

As more advanced, higher speed electrophotographic copiers, duplicators and printers were developed, degradation of image quality was encountered during extended cycling. Moreover, complex, highly sophisticated duplicating and printing systems operating at very high speeds have placed stringent requirements including narrow operating limits on photoreceptors. For example, the numerous layers found in many modern photoconductive imaging members must be highly flexible, adhere well to adjacent layers, and exhibit predictable electrical characteristics within narrow operating limits to provide excellent toner images over many thousands of cycles.

One typical type of multilayered imaging member that has been employed as a belt in electrophotographic imaging systems comprises a substrate, a conductive layer, a hole blocking layer, an adhesive layer, a charge generating layer, a charge transport layer, and a conductive ground strip layer adjacent to one edge of the imaging layers. This imaging member may also comprise additional layers, such as an anti-curl back coating layer to flatten the imaging member and an optional overcoating layer to protect the exposed charge transport layer from wear.

The electrophotographic imaging flexible member is usually fabricated from a sheet cut from an imaging member web. The sheets are generally rectangular in shape. All sides may be of the same length, or one pair of parallel sides may be longer than the other pair of parallel sides. The expression rectangular,″ as employed herein, is intended to include four sided sheets where all sides are of equal length or where the length of two equal parallel sides is unequal to the other two equal parallel sides.

The sheets are fabricated into a belt by overlapping opposite marginal end regions of the sheet. A seam is typically produced in the overlapping marginal end regions at the site of joining. Joining may be effected by any suitable means. Typical joining techniques include welding (such as ultrasonic welding), gluing, taping, pressure heat fusing and the like.

Ultrasonic welding is a preferred method for joining flexible polymeric sheets because of its speed, cleanliness (absence of solvents) and production of a strong and narrow seam. In the ultrasonic seam welding process, ultrasonic energy transmitted to the overlap region is used to melt the coating layers of the photoconductive sheet thereby providing direct substrate to substrate contact of the opposite ends and fusing them into a seam. This ultrasonic welding joining process can, however, result in the formation of flashing and splashing that project, respectively, beyond the edges of the belt and onto either side of the overlap region of the seam.

The seam flashing can be removed from either edge of the belt with the use of, for example, a reciprocating punch or notching device. The reciprocating punch has a small circular cross section and removes the flashing and part of the seam to form a generally semi-circular notch in either edge of the belt. Unfortunately, because of the overlap and presence of seam splashing, a typical flexible imaging member is about 1.6 times thicker in the seam region than elsewhere on the imaging member (e.g. about 188 micrometers versus 116 micrometers). Instead of overlapping the ends, one may also weld ends that are abutted end to end to reduce the seam thickness. With this alternative approach, the ends of the photoreceptor may be cut at a slight bias angle relative to the major surfaces of the belt to enhance abutting. But this butt joined embodiment has been found to exhibit weaker seam strength than a conventional overlapped seam.

Moreover, embodiments with abutted ends have ends cut at a slight angle relative to a major surface of the belt; the ends tend to slide over each other during the seam welding operation, causing the final welded photoreceptor belt to have a larger circumference than theoretical situations where the butt ends could somehow be maintained in precise alignment with each other during the entire ultrasonic seam welding process.

The photoreceptor belt is subjected to varying degrees of bending strain as it is cycled over a plurality of belt support rollers in an electrophotographic imaging apparatus. The excessive thickness of the photoreceptor belt in the seam region due to the presence of the splashing and seam overlap results in a larger induced bending strain at the seam than at the remainder of the photoreceptor belt as the seam passes over each support roller. It has been theoretically calculated that the bending stress is directly proportional to the thickness of the photoreceptor, but inversely related to the diameter of a belt support roller when the photoreceptor belt passes over each roller during cycling. This indicates that the combination of a thin photoreceptor seam design with larger belt support rollers is the most favorable choice for strain reduction and extended photoreceptor belt service life. Generally, small diameter support rollers are highly desirable for simple, reliable self-stripping copy paper systems in compact electrophotographic imaging apparatus requiring photoreceptor belt operation in a very confined space.

Unfortunately, small diameter rollers, e.g., less than about 0.75 inch (19 millimeters) in diameter, raise the mechanical performance criteria threshold for photoreceptor belts to such a high level that premature photoreceptor belt seam failure frequently occurs, thereby shortening the service life of the belt. For example, when bent over a 19 millimeter diameter roller, a conventional commercially available XEROX® welded photoreceptor belt seam may develop a 0.96 percent induced bending strain. Compared to a 0.59 percent tensile bending strain for the rest of the belt, the 0.96 percent tensile strain in the seam region of the belt represents a 63 percent increase in stress placed upon the overlapped seam and splashing which, in turn, leads to the development of seam cracking, delamination, and tearing during extended cycling.

Under dynamic fatiguing conditions, the seam overlap and splashing provide a focal point for stress concentration and become the initial point of failure that effects the mechanical integrity of the belt. Thus, the excessive thickness of the seam overlap and splashing tends to shorten the mechanical life of the seam and adversely affect service life of the flexible member belt in copiers, duplicators, and printers.

Moreover, excessive seam thickness and irregular splash protrusions can cause the development of large lateral friction forces against cleaning blades during electrophotographic imaging and cleaning cycles. This mechanical interaction has been observed to severely affect the life of the imaging belt, exacerbates blade wear, and induces belt velocity variations during belt cycling.

In an electrophotographic imaging machine employing a liquid ink development system, the overlapped joint of an ultrasonically welded seam is too thick to provide proper imaging belt operation against various subsystem stations. For example, the seam region can interact and physically interfere with metering roll and development roll functions.

Although other innovative efforts to improve seam morphology such as seam surface smoothing by polishing; seam life extension by scribing the top surface of the seam to relieve bending stress/stress; and shape alteration of imaging sheet ends by mechanical grinding prior to overlapping and welding have all been successfully demonstrated, these techniques nevertheless are cumbersome and very costly to implement. To provide mechanically robust imaging member belts that meet the future electrostatographic imaging requirements, it has therefore become apparent that preparation of seamless imaging member belts is important to eliminating the flexible belt's seam-associated shortcomings.

The following may be relevant to certain aspects of the invention:

U.S. Ser. No. 09/460,896 entitled Imageable Seam Intermediate Transfer Belt Having An Overcoat, by Edward L. Schlueter, Jr. et al., and U.S. Ser. No. 09/460,821, entitled Imageable Seam Intermediate Transfer Belt, by Gerald M. Fletcher et al., both filed on Dec. 14, 1999.

U.S. Pat. No. 5,688,355 issued to Yu on Nov. 18, 1997 A seamed flexible belt and process for fabricating the belt is disclosed. Multiple-layered electrophotographic imaging member belt is prepared by utilizing excimer laser ablation technique to remove precision amount of material from the bottom and the top of two opposite ends of a imaging member cut sheet prior to overlapping the two opposite ends and ultrasonically weld the overlap into a welded seam. The resulting multi-layered imaging member belt thus obtained has a welded seam of little added thickness and reduced amount of seam splashing formations.

U.S. Pat. No. 5,698,358 issued to Yu on Dec. 16, 1997 A process including providing a flexible substantially rectangular sheet having a first major exterior surface opposite and parallel to a second major exterior surface, removing or displacing material from the first major exterior surface adjacent and parallel to a first edge of the sheet to form a new first surface having an elongated, curvilinear S shaped profile when viewed in a direction parallel to the first edge, overlapping the new first surface and a second surface adjacent a second edge of the sheet whereby the first new surface contacts the second surface to form a mated surface region, the second surface being adjacent to or part of the second major exterior surface to form the sheet into a loop, the second edge being at an end of the sheet opposite from the first edge, and permanently joining the new first surface to the second surface into a seam to form a seamed belt. The resulting welded belt has a seam thickness of less than about 120 percent of the total thickness of the belt.

U.S. Pat. No. 4,776,904 issued to Chariton et al. on Oct. 11, 1988—Discloses a method of making a multilayer analytical test element comprises providing layers at least one of which is responsive to detect a ligand in a liquid sample, or to detect the ligand binding capacity of the sample, and at least one other layer that is fusible when subjected to sonic energy, arranging the layers one on top of the other together to form a composite blank of layers, subjecting the composite to ultrasonic or laser energy to cut the composite to the desired dimension of the test element and to simultaneously weld the layers at the edges thereof, said energy softening and fusing the fusible layer to thereby bond the layers together.

U.S. Pat. No. 4,758,486 issued to Yamazaki et al. on Jul. 19, 1988—The fabrication of an endless belt photoconductor is disclosed. The belt comprises an electroconductive support material, a photoconductive layer formed thereon, a joint portion by which the electrophotographic photoconductor is worked into the shape of an endless belt. The joint portion is covered with an electroconductive overcoating layer comprising a polymeric material having a glass transition temperature of −10° C. or lower and finely divided electroconductive particles, or the joint portion further comprises a joint reinforcement resin layer which is interposed between the electroconductive overcoating layer and the photoconductive layer in the joint portion.

U.S. Pat. No. 4,883,742 issued to Wallbillich et al. on Nov. 28, 1989—Joining of an end and/or lateral areas of thermoplastically processable photosensitive layers is disclosed. The end and/or lateral areas of photosensitive layers are overlapped to avoid bubbles and air cavities between the end and/or lateral areas. The overlapped area is then heated under pressure to firmly join the areas together. The joined photosensitive layer is then treated and smoothed to shape it to size.

U.S. Pat. No. 4,41 0,575 issued to Obayashi et al. on Oct. 18, 1983—A method is disclosed for lap welding fabrics together by superposing two end portions of one or two fabrics on each other with an interposing synthetic polymeric bonding tape between the superposed two end portions. The method includes applying a high frequency wave treatment and/or heat treatment to the interposed portion of the bonding tape through at least one of the superposed end portions while pressing them, to melt the interposed portion of the bonding tape thereby lap welding the end portions of the fabric or fabrics to each other. At least one side edge portion of the tape extends outwardly over an edge of the end portion which is deformed from the forces absorbed when the heat treatment and frequency wave treatment are applied. The fabrics may be made of any fiber.

U.S. Pat. No. 3,493,448 issued to Powell et al. on Feb. 3, 1970—A method of splicing photographic film with an ultrasonic welding apparatus is disclosed. The method comprises sand blasting the ends to be welded and chilling the fused ends to be fused together. The ends of the photographic film are overlapped and compressed together. Heat is introduced into the film ends to fuse them together.

U.S. Pat. No. 4,878,985 issued to Thomsen et al. on Nov. 7, 1989—A process and apparatus for fabricating belts are disclosed in which the leading edge of a web is conveyed from a supply roll into a belt loop forming station, the web is cut a predetermined distance from the leading edge to form a web segment having the leading edge at one end and a trailing edge at the opposite end, the lower surface of the web adjacent the leading edge is inverted, the lower surface of the web adjacent the trailing edge is inverted, the inverted leading edge and the inverted trailing edge are overlapped to form a loop of the web segment loosely suspended from the joint formed by the overlapped leading edge and trailing edge, the loop of the web segment at the belt loop forming station is transferred to an anvil, the loop of the web segment on the anvil is conveyed to a welding station and the overlapped leading edge and trailing edge are welded together on the anvil to form a belt welded at the joint.

U.S. Pat. No. 4,430,146 issued to Johnson on Feb. 7, 1984—Apparatus for splicing thermoplastic coated belts is disclosed having a pair of longitudinal bars on which are respectively mounted platen heating assemblies, one bar being centrally supported pivotably on a clamping arrangement and the other bar being removably connectable with the clamping arrangement in a manner permitting pivotable positioning of the bar about one end thereof for pivotable disposition of the bars with their platens in opposed facing parallel relation at various spacings therebetween to permit uniform engagement by the bars of opposite sides of belt ends of varying thickness, and the clamping arrangement is adapted for bolted drawing of the bars together to grippingly retain the belt ends. The components of the apparatus are arranged for serial flow of direct electrical current through the heating assemblies and therebetween through the bars and the clamping arrangement for quick, low energy heating of the belt ends to fuse the thermoplastic material thereof. The apparatus facilitates a new belt splicing method eliminating the conventional need to use supplementary liquid thermoplastic material to effect bonding of the belt ends and thus a new belt splice is provided the spliced ends of which are bonded only by fusion of their respective thermoplastic material.

A prior art puzzle-cut approach to seamed belts significantly improves the seam''s mechanical strength. U.S. Pat. No. 5,514,436, issued May 7, 1996, entitled Puzzle Cut Seamed Belt; U.S. Pat. No. 5,549,193 entitled Endless Seamed Belt with Low Thickness Differential Between the Seam and the Rest of the Belt; and U.S. Pat. No. 5,487,707, issued Jan. 30, 1996, entitled Puzzle Cut Seamed Belt With Bonding Between Adjacent Surface By UV Cured Adhesive teach the puzzle-cut approach. While the puzzle-cuts described in the forgoing patents improve the seam''s strength, further improvements would be beneficial. Furthermore, there are other difficulties when transferring toner onto and off of a seam of a seamed intermediate image transfer belt.

Ideally the seam should be strong, smooth, and mechanically uniform. While prior art techniques can yield suitably smooth and mechanically uniform seam regions, they often still have marginal electrical continuity, adversely affecting the imageability of the seam region.

An example of an imageable seam intermediate transfer belt 8 made using prior art methods can look much like the belt illustrated in FIG. 1. That belt includes either only a semiconductive substrate layer 10 or may be coated with various layers of coatings and that has its ends joined together to form a continuous belt using mechanically interlocking puzzle-cut tabs that form a seam 11. While the seam is illustrated as being perpendicular to the two parallel sides of the substrate layer the seam could be angled or slanted with respect to the parallel sides. Reference U.S. Pat. Nos. 5,487,707; 5,514,436; 5,549,193; and 5,721,032 for additional information on puzzle-cut patterns. Typically, the seam 11 is about ¼ inch wide.

The substrate layer 10 can be made from a number of different materials, including polyesters, polyurethanes, polyimides, polyvinyl chlorides, polyolefins (such as polyethylene and polypropylene) and/or polyamides (such as nylon), polycarbonates, or acrylics, or blends or alloys of such materials. If required, the selected material is modified by the addition of an appropriate filler such that the substrate layer has a desired electrical conductivity. Appropriate fillers can include, for example, carbon, Accufluor® fluorinated carbon black, and/or polyanaline, polythiophene, or other conductive fillers or polymers. Donor salts can also be used. The substrate layer material should have the physical characteristics appropriate to an intermediate transfer application, including good tensile strength (Young''s modulus, typically 1·10³ to 1·10⁶ Newton/m², resistivity (typically less than 10¹³ ohm·cm volume resistivity, greater than 10 ohms/square lateral resistivity), thermal conductivity, thermal stability, flex strength, and high temperature longevity. See the previously referenced U.S. patent applications Ser. No. 09/460,896, entitled Imageable Seam Intermediate Transfer Belt Having An Overcoat, by Edward L. Schlueter, Jr. et al., and Ser. No. 09/460,821 entitled Imageable Seam Intermediate Transfer Belt, by Gerald M. Fletcher et al., both filed on Dec. 14, 1999 and issuing, respectively, as U.S. Pat. Nos. 6,245,402 on Jun. 12, 2001, and 6,261,659 on Jul. 17, 2001.

FIG. 2 shows a top view of the puzzle-cut tab pattern in more detail. Each tab is comprised of a neck 14 and a node 16 that fit into female 15 interlocking portions. The tabs are beneficially formed using a laser micro-machining system described subsequently. The interlocking tabs mate so as to reduce the stress concentration between the interlocking elements and to permit easy travel around curved members, such as rollers 12 shown in FIG. 1.

FIG. 3 shows a top view of the puzzle-cut tabs of FIG. 2 interlocked together. Physically interlocking the puzzle-cut tabs may require pressure when mating the tabs. Interlocking produces a gap between the mutually mating elements that is called a kerf 20. As shown in FIG. 4 the interlocking tabs are held together and bonded using an adhesive 22 that fills the kerf. The adhesive is designed to be physically, chemically, thermally, mechanically, and electrically compatible with the substrate layer material. Seams with a 25 micron kerf have been typical for the puzzle-cut seam, while a kerf less than about 5 microns can be preferred.

Significantly, the adhesive and the puzzle-cut tabs act together to create a strong seam. The relative electrical properties of the adhesive and the substrate are very important because they significantly affect the transfer characteristics of the resulting seam as compared to the transfer characteristics of the rest of the belt. Therefore, the adhesive should produce a seam that has electrical properties that corresponds to that of the substrate layer. That is, under operating conditions a seam should create an electrostatic transfer field in the toner transfer zones that is within at least 20%, preferably within 10%, of the electrostatic transfer field that is present for the remainder of the belt. Ideally, the seam electrical properties are substantially the same as the substrate layer and have substantially the same electrical property dependence as the substrate on all important factors, such environment, applied field, and aging. However, significant differences in electrical properties can be allowed for some imageable seam conditions as discussed subsequently. The adhesive electrical properties can be met by mixing fillers or additives with an adhesive. For example, an adhesive might contain silver, indium tin oxide, Cul, SnO₂, TCNQ, Quinoline, carbon black, NiO and/or ionic complexes such as quaternary ammonium salts, metal oxides, graphite, or like conductive fillers and conductive polymers such as polyanaline and polythiophenes.

To alleviate some of the problems associated with prior art methods, laser ablation has been employed in seam preparation. Prior efforts in which portions of the belt ends are ablated away with excimer lasers before overlap reduce seam region thickness and related problems. However, these efforts still leave margins for improvement. Further, these efforts have approached the problem by manipulating rectangular sheets of multiple layered material, which can pose problems with proper absorption of laser energy during laser ablation. Thus, there is a need for a more efficient method of manufacture producing even better seam regions.

Embodiments of the subject invention provide a method of fabricating a flexible electrostatographic imaging member belt substantially free of prior art seam region problems by manipulating belt substrate material, then applying coatings to the belt-shaped substrate to form the electrostatographic belt. The resultant belt has far smaller seam region thickness increases than any prior method of manufacture and substantially obviates the need for mechanically manipulating the seam. In addition, because the coatings are unperturbed after application, the electrostatographic properties of the seam region differ negligibly from those of other regions of the belt.

Embodiments of the subject invention begin by procuring a flexible substrate support sheet, then proceed by bombarding a first part of the substrate support sheet with first emissions, such as a laser beam or a particle beam, to produce first desired features on the substrate support sheet. Similarly, embodiments employ second emissions to form second desired features, complementary to the first desired features, on the substrate support sheet. The first and second desired features are produced, at least in part, by removal of material from the illuminated regions of the substrate support sheet. For example, the first desired features can include a groove formed by moving the substrate support sheet and the emissions spot relative to each other along a first edge of the substrate support sheet, leaving a “tab” along the first edge; the second desired features can include a complementary groove and tab along a second edge of the substrate support sheet. Then, by overlapping said first desired pattern with said second desired pattern, embodiments produce a thin profile belt with substantially no seam height and substantially no increase in belt thickness in the seam region. Embodiments advantageously employ ultrasonic welding to bond the overlapped region to avoid problems associated with heat-generating and adhesive-based bonding techniques, though such could be employed with appropriate precautions. Embodiments then proceed with coating the seamed belt with a photoconductive material by, for example, dip or spray coating technique, to form a seamless flexible electrostatographic belt.

Embodiments include a seamless flexible electrostatographic imaging member belt fabrication method comprising providing a flexible substrate support sheet, producing first desired features on a first portion of the substrate support sheet, including removing material from the substrate support sheet with first emissions, producing second desired features on a second portion of the substrate support sheet complementary to the first desired features, including removing material from the substrate support sheet with second emissions, overlapping the first and second desired features, bonding the first desired pattern with the second desired pattern to produce a seamed belt and applying at least one coating the substrate support sheet. Alternatively, embodiments can include a seamless flexible electrostatographic imaging member belt fabrication method comprising providing a flexible substrate support sheet, producing first desired features on a first portion of the substrate support sheet, including removing material from the substrate support sheet with first emissions, producing second desired features on a second portion of the substrate support sheet complementary to the first desired features, including removing material from the substrate support sheet with second emissions, removing material from the substrate with first and second emissions including inducing a desired shape in at least one of the first and second emissions by passing the at least one of the first and second emissions through at least one mask, removing material from the substrate with first emissions further including inducing relative motion between the laser beam and the substrate support sheet, overlapping the first and second desired features, bonding the first desired features with the second desired features to produce a substantially seamless belt, and applying at least one coating over the substrate support sheet, the at least one coating including a photoconductive coating.

For typical intermediate transfer belt embodiments, a substantially seamless substrate belt is prepared according to the above descriptive manners and procedures to give a single layer intermediate transfer belt.

### BRIEF DESCRIPTION OF DRAWINGS

A more complete understanding of the seam configuration of a flexible belt of the present invention can be achieved and become apparent by reference to the accompanying drawings wherein:

FIG. 1 is an isometric representation of a puzzle-cut seamed intermediate transfer belt.

FIG. 2 is a top down view of the puzzle-cut tab pattern used in the belt of FIG. 1.

FIG. 3 shows the puzzle-cut tabs of FIG. 2 interlocked together.

FIG. 4 shows the puzzle-cut tabs of FIG. 3 with the kerf filled with an adhesive.

FIG. 5 shows a cross-sectional view of a first embodiment seam structure that is in accordance with the principles of the present invention.

FIG. 6 shows a cross-sectional view of a second embodiment seam structure that is also in accordance with the principles of the present invention.

FIG. 7 shows a perspective, schematic view of a laser micro-machining system that is suitable for producing the thin profile seam structures of the present invention.

### DETAILED DESCRIPTION

While the principles of embodiments of the invention are described below in connection with embodiments employing an excimer laser micro-machining system for producing thin profile seamed belts having complex, but improved, seam structures, it should be understood that the present invention is not limited to that particular embodiment. On the contrary, embodiments are intended to cover all alternatives, modifications, and equivalents as may be included within the spirit and scope of the appended claims. For reason of convenience, the following description will focus only on the fabrication of both single layer seamed flexible substrate support belts and intermediate image transfer belts; nonetheless, the process of this invention is also applicable for the creation of other types of flexible belts, such as sheet transport belts, document handler belts, toner transporting donor belts, drive belts, conveyor belts, dual-layer flexible intermediate image transfer belts, dual layer image transfuse belts, multi-layered electrostatographic imaging member belts and the like. It shall be noted that the partial cutting into or material removal to create the desired pattern at the opposite edges of the substrate support sheet prior to overlapping can conveniently be carried out by mechanical grinding or polishing technique, other than laser, if the substrate support sheet exceeds 10 mils in thickness. Further, other types of emissions can be employed, such as maser and high energy particle beams.

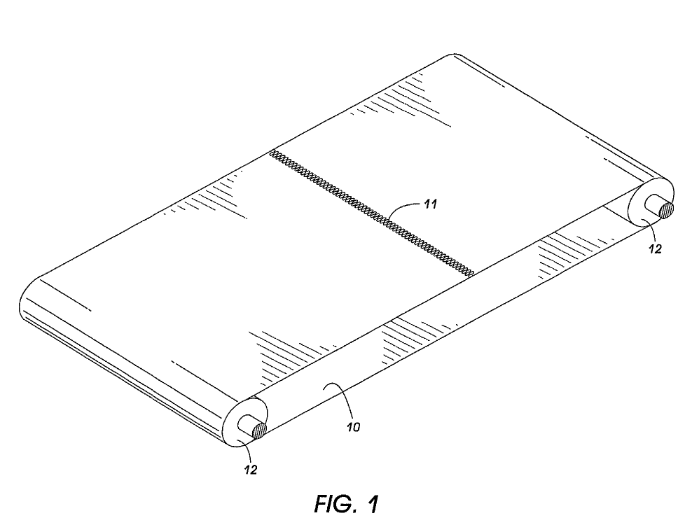

Rather than manipulating a piece of material already treated for use as a photoreceptor, embodiments start with a piece of a substrate material suitable for use as the base for a photoreceptor belt 8, such as that shown in FIG. 1. The piece of substrate material 10 is cut, the ends prepared for joining, and bonded to form a belt, and is then, for example, coated over with subsequent layers to form a photoreceptor belt. This yields a photoreceptor belt with negligible variations in photoelectric properties across the joint of the belt since the photoconductive and other coatings are applied to the substrate after the joining process is complete.

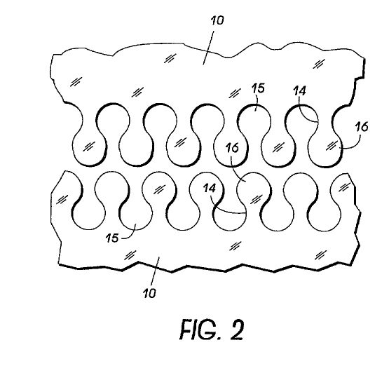

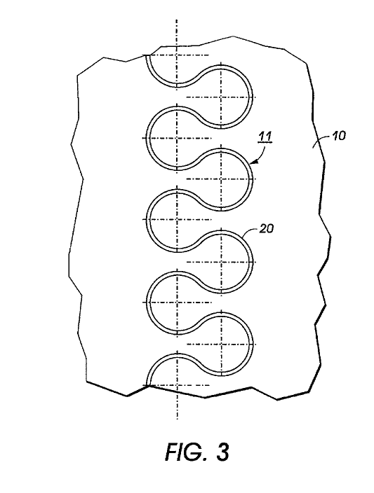

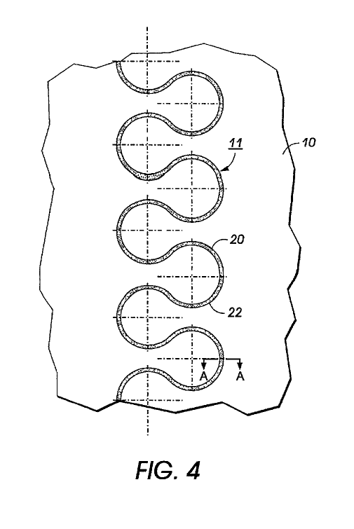

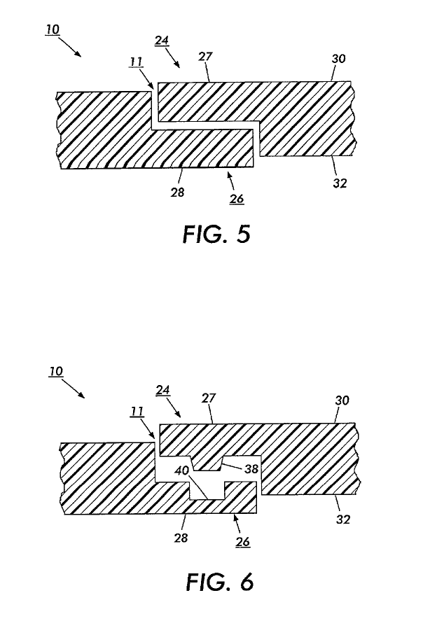

Belts according to the principles of the present invention differ from those of the prior art by adding various seam complexities along a third dimension, that being perpendicular to the seam planes in FIGS. 1-4. FIG. 4 identifies a section A-A, which will generally be used to locate various alternative embodiment seam structures in FIGS. 5 and 6.

It should be understood that a seam structure of the substrate belt extends along the seam, and that the adhesive 22 is disposed both along the seam and across the seam structure. To that end, the adhesive should have a viscosity such that it readily wicks into the kerf. Additionally, the surface energy of the adhesive should be compatible with the substrate layer material such that the adhesive adequately wets and spreads. Furthermore, the adhesive should remain flexible and should adhere well to the substrate layer material. Finally, the adhesive also should have low shrinkage during curing. As an example, the adhesive can be a hot melt adhesive that is heated and pressed into the seam such that the adhesive is flattened, making it as mechanically uniform as possible with the substrate layer 10. Alternatively, the adhesive can be an epoxy-like material, a UV curable adhesive including acrylic epoxies, polyvinyl butyrals, or the like. Further, the adhesive can be substantially the substrate material itself, either applied during a separate adhesive application step or else by melting the two ends sufficiently to cause adhesion of the mutually mating elements. Finally, the adhesives may be electrically modified as required for the particular application. Following the application of the adhesive, the seam 11 can be finished by buffing, sanding, or micro polishing to achieve a smooth topography.

As in the prior art, the relative electrical properties of the adhesive and the substrate are very important because they can significantly affect the transfer characteristics of the resulting seam as compared to the transfer characteristics of the rest of the belt. Therefore, the adhesive should produce a seam that has electrical properties that corresponds to that of the substrate layer. That is, under operating conditions a seam should create an electrostatic transfer field in the toner transfer zones that is within at least 20%, preferably within 10%, of the electrostatic transfer field that is present for the remainder of the belt. Ideally, the seam electrical properties are substantially the same as the substrate layer and have substantially the same electrical property dependence as the substrate on all important factors, such environment, applied field, and aging. However, significant differences in electrical properties can be allowed for some imageable seam conditions as discussed subsequently. The adhesive electrical properties can be met by mixing fillers or additives with an adhesive. For example, an adhesive might contain silver, indium tin oxide, Cul, SnO₂, TCNQ, Quinoline, carbon black, NiO and/or ionic complexes such as quaternary ammonium salts, metal oxides, graphite, or like conductive fillers and conductive polymers such as polyanaline and polythiophenes.

FIG. 5 shows a first seam structure that can beneficially be fabricated, with a rectangular or parallelogram cut sheet having straight cut ends, using the principles of the present invention. The straight ends 24 and 26 of a belt 10 are cut to form rabbeted tongues 27 and 28 that overlapped fit together to form a seam 11 such that the outer surface 30 and the inner surface 32 of the belt are substantially flush across the seam. Since the tongues have a width of from about 0.8 mm to about 2.5 mm, the contacting surfaces have an increase in surface area many times larger than the prior art puzzle-cut seam joint in a typical 80 micrometer thick intermediate image transfer belt, it is therefore enabling the adhesive 22 to form a stronger seam. Alternatively, the overlap fit together ends can conveniently be ultrasonically welded to yield a seam having no added seam thickness.

FIG. 6 shows a second seam structure embodiment that can beneficially be fabricated using the principles of the present invention. Like the first seam structure, this structure includes rabbeted tongues 34 and 36 that fit together to form a seam 11 such that the outer surface 30 and the inner surface 32 of the belt are substantially flush across the seam. However, in this embodiment the tongue 34 includes a protrusion 38 that fits into a channel 40. The tongues 34 and 36 not only increase the seam''s surface area, thus enabling the adhesive 22 to form a stronger seam, but the protrusion 38 and channel 40 add a mechanical impediment to seam separation. Of course, the increased seam area along the protrusion 38 also improves the strength of the seam. The seam overlap configuration can again be bonded together to give a strong seamed belt, by either using an adhesive or ultrasonic welding technique as described in FIG. 5.

Prior art puzzle-cut seamed intermediate transfer belts were usually fabricated from a blank, planar sheet of suitable belt material that was puzzle-cut, one end at a time, using an intricate and expensive mechanical puzzle-cutting die that extends across the width of the belt. This requires the belt blank to be aligned twice with the elongated die. After cutting, the ends are mechanically aligned, the puzzle-features interlocked to form a mechanically coupled seam, and a suitable adhesive is applied to the seam and cured to form a seamed belt. It is possible to modify this prior art process to produce 3-dimensional seam structures, for example, by including cutting, etching, grinding, or milling steps before interlocking the seam. However, the resulting process is slow, labor intensive, and not suitable for large scale, low cost precision manufacturing. A second prior art puzzle-cut seamed intermediate transfer belt fabrication process uses a laser to simultaneously cut two edges of a continuously fed web of suitable material. However, that process is not suitable for producing 3-dimensional structures as shown in FIGS. 5 and 6.

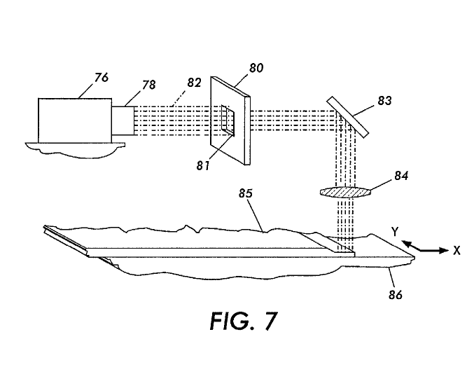

One relatively simple, low cost process for continuous manufacture of puzzle-cut seamed intermediate transfer belts having 3-dimensional seam structures of this invention is laser micro-machining. FIG. 7 shows a perspective, schematic view of a suitable laser micro-machining system.

As shown in FIG. 7, a fixed laser 76 having beam-spreading optics 78 illuminates a quartz glass mirrored-surface 80 (or thin metal mask) bearing a mask 81 having a desired cutting pattern with a laser beam 82. The laser beam 82 passes through the mask only in the desired cutting pattern. Typically, the mask features are 210 times larger than the actual desired cutting pattern. For convenience, a mirror 83 directs the laser beam along a desired path. A focusing and de-magnification lens 84 is appropriately positioned in the desired path between the mask 81 and a belt substrate 85 that is being micro-machined. The lens 84 appropriately de-magnifies the cutting pattern such that the desired features can be cut into the belt substrate. The mask pattern causes the belt substrate to be illuminated with the shape of one or more features that are to be produced. For example, a rectangular cut can be laser milled in the belt edge by illuminating the belt substrate appropriately. A feature can be continuously cut across the width of the belt by moving the belt material using a vacuum stage X-Y platform 86, or by using some other suitable apparatus. Alternatively, the focused laser beam can be moved across the belt to continuously form the cut.

Complex structures can be cut using two or more masks, each mask having an appropriately sized feature. Features can then be successively aligned to produce the complex feature. For example, one mask might be used to cut a step along an edge of a belt substrate during a first pass, and then another mask might cut an embedded profile within that step during a second pass. Furthermore, the laser micro-machining process might use only one laser to process both ends of the belt, or plural lasers might be used. For example, a laser might be dedicated to each end of the belt, and/or multiple lasers might work on each end.

In any event, after the belt is laser micro-machined a suitable adhesive can be placed over the mating surfaces, the puzzle-cut seams and their seam structures are interlocked, and then the adhesive is cured.

As will be readily understood by those skilled in the appropriate arts, the optimum laser system, energy density, and/or pulse repetition rates will depend upon the particular application. Significant variables include the particular belt material and its thickness, the required cutting/milling rate, the belt material motion, the pattern being produced, and the required feature accuracy. However, to provide a starting point, an ultraviolet (UV) laser having a wavelength of 248 nm or 192 nm will generally be suitable for cutting belts of polyaniline and carbon-black filled polyimide substrates, including those having polyanaline and or zeloc filled polyimide films. Suitable lasers include Excimer and triple frequency multiplied YAG lasers (which are believed capable of effectively producing suitable UV frequencies).

Using the thin profile seam configurations described above and shown, for example, in FIGS. 5 and 6, the very same process is also employed to create a single layer flexible substrate support belt and then used for seamless flexible photoreceptor belt preparation.

The flexible single layer seamed belt and a process for fabricating the seam that can virtually provide physical, mechanical, and electrical functions like a seamless flexible belt. The fabricated single layer flexible seamed belt can be a substrate support belt, imageable intermediate image transfer belt, conveyor belt, motor drive belt, machine document handling belt, sheet transport belt, torque assist drive belt, or the like which has a thin profile improved seam design and performs function like a virtual seamless belt. For multi-layered seamless electrostatographic imaging member belt (or dual-layer seamless intermediate image transfer belt or image transfuse belt) preparation, a single layer flexible seamed substrate support belt of this invention is then overcoated with subsequent layers either by spraying or solution dip-coating technique to form the desired seamless imaging member belt.

The fabrication process of the invention single layer flexible seamed substrate support belt for seamless multi-layered electrostatographic imaging member belt preparation comprises providing a mechanically robust single layer flexible substrate support sheet, say a 3-mil thick biaxially oriented poly(ethylene terephthalate) substrate used in typical photoreceptor belts, having a substantially rectangular or parallelogram shape, a first major exterior surface opposite and parallel to a second major exterior surface and a first edge surface of a first marginal end region opposite to and parallel with a second edge surface of a second marginal end region; removing by ablation with a masked excimer laser beam a first segment of material from the first major exterior surface at the first marginal end region to form at least one recess comprising at least one fresh substantially flat surface intersecting at least one adjacent wall at a right angle, the flat surface being substantially parallel to and spaced from the second major exterior surface; removing by ablation with a masked excimer laser beam a second segment of material from the second major exterior surface at the second marginal end region to form at least one recess comprising at least one fresh substantially flat surface intersecting at least one adjacent wall at a right angle, the flat surface being substantially parallel to and spaced from the first major exterior surface; overlapping the first marginal end region over the second marginal end region whereby the fresh substantially flat surface at the first marginal end surface mates with the fresh substantially flat surface at the second marginal end surface; and bonding the overlapped end regions together to form a thin profile seam. Additionally, features, such as the puzzle cut, can be imposed by placing a template opaque to the emissions used over the straight cut end portion of the substrate support sheet to be ablated. The bonding of the overlap region of these excimer laser shape altered opposite ends of the substrate support sheet into a seam joint can be achieved by ultrasonic welding process, gluing, heat fusing, stapling, or the like. For poly(ethylene terephthalate) substrate support, ultrasonic seam welding is preferred based on ease of fabrication, seaming simplicity, cost, cycle-time, and resulting seam rupture strength considerations. If required, the ultrasonically welded seam of the substrate support belt is also mechanical polished to give optimum seam profile.

It is important to emphasize that the reason of choosing excimer laser ablation for substrate ends shape alteration prior to overlapping and seam welding into an invention seamed flexible belt is due to the fact that material removal from the thin poly(ethylene terephthalate) substrate support film is a precision micro photo-machining process requires no application nor generation of thermal energy to cause substrate belt distortion. However, thick flexible belt preparation, for example a conveyor belt, mechanical machining process is preferred to speed up the operation.

The flexible substrate support may be opaque or substantially transparent and may comprise numerous materials having the required mechanical properties. Accordingly, the substrate may comprise a layer of an electrically non-conductive or conductive material such as an inorganic or an organic composition. As electrically non-conducting materials there may be employed various thermoplastic resins known for this purpose including polyesters, polycarbonates, polyimides, polyamides, polyurethanes, and the like which are flexible in thin webs. The electrically insulating or conductive substrate should be flexible and in the form of an endless flexible belt. Preferably, the endless flexible belt shaped substrate support comprises a commercially available biaxially oriented polyester.

The thickness of the substrate support layer depends on numerous factors, including flexural rigidity, beam strength, mechanical toughness, and economical considerations. Thus, the substrate layer used for a flexible belt application may be of substantial thickness, for example, about 150 micrometers, or of a minimum thickness of about 50 micrometers, provided that it produces no adverse effects on the belt. Preferably, the thickness of the substrate support layer is between about 75 micrometers and about 100 micrometers for optimum flexibility, beam rigidity, and minimum stretch during cycling.

Where a separate flexible conductive layer is employed over the substrate support belt, it may vary in thickness over substantially wide ranges depending on the optical transparency and degree of flexibility desired for the final seamless electrostatographic member belt. Accordingly, for a flexible electrostatographic imaging member device, the thickness of the conductive layer may be between about 20 angstroms and about 750 angstroms, and more preferably between about 100 angstroms and about 200 angstroms for an optimum combination of electrical conductivity, flexibility and light transmission. The flexible conductive layer may be an electrically conductive metal layer formed, for example on the substrate support belt, by any suitable coating technique, such as a vacuum sputtering process or a vacuum depositing technique. Typical metals include aluminum, copper, gold, zirconium, niobium, tantalum, vanadium and hafnium, titanium, nickel, stainless steel, chromium, tungsten, molybdenum, and the like. Regardless of the technique employed to form the metal layer, a thin layer of metal oxide forms on the outer surface of most metals upon exposure to air. Thus, when other layers overlying the metal layer are characterized as “contiguous” layers, it is intended that these overlying contiguous layers may, in fact, contain a thin metal oxide layer that has formed on the outer surface of an oxidizable metal layer. A typical electrical conductivity for conductive layers for electrostatographic imaging member belts in slow speed copiers is about 10⁻² to 10⁻³ per ohms/square.

After formation of an electrically conductive surface, say for seamless photoreceptor belt preparation, a hole blocking or electron blocking layer, hereinafter referred to as a charge blocking layer, may be applied thereto. Generally, electron blocking layers for positively charged photoreceptors allow holes from the imaging surface of the photoreceptor to migrate toward the conductive layer and hole blocking layers for negatively charged photoreceptors allow electrons from the imaging surface of the photoreceptor to migrate toward the conductive layer. Any suitable charge blocking layer capable of forming an electronic barrier to holes or electrons between the adjacent photoconductive layer and the underlying conductive layer may be utilized. The charge blocking layer should be continuous and have a dry thickness of less than about 0.2 micrometer.

An adhesive layer is usually applied to the charge blocking layer. Any suitable adhesive layer well known in the art may be utilized. Typical adhesive layer materials include, for example, polyesters, polyurethanes, and the like. Satisfactory results may be achieved with the adhesive layer thickness between about 0.05 micrometer and about 0.3 micrometer.

Any suitable charge generating (photogenerating) layer may be applied onto the adhesive layer. Charge generating layers are well know in the art and can comprise homogeneous layers or photoconductive particles dispersed in a film forming binder. Examples of charge generating layers are described, for example, in U.S. Pat. No. 3,357,989, U.S. Pat. No. 3,442,781, and U.S. Pat. No. 4,41 5,639, the disclosures thereof being incorporated herein in their entirety. Other suitable photogenerating materials known in the art may also be utilized, if desired.

Any suitable polymeric film forming binder material may be employed as the matrix in of the photogenerating layer. Typical polymeric film forming materials include those described, for example, in U.S. Pat. No. 3,121,006, the disclosure thereof being incorporated herein in its entirety. The photogenerating composition or pigment may be present in the film forming binder composition in various amounts. Generally, from about 5 percent by volume to about 90 percent by volume of the photogenerating pigment is dispersed in about 10 percent by volume to about 90 percent by volume of the resinous binder. Preferably from about 20 percent by volume to about 30 percent by volume of the photogenerating pigment is dispersed in about 70 percent by volume to about 80 percent by volume of the resinous binder composition.

The photogenerating layer generally ranges in thickness from about 0.1 micrometer to about 5 micrometers, and more preferably from about 0.3 micrometer to about 3 micrometers. The photogenerating layer thickness is related to binder content. Higher binder content compositions generally require thicker layers for photogeneration.

The charge transport layer may comprise any suitable transparent organic polymer or non-polymeric material capable of supporting the injection of photogenerated holes or electrons from the charge generating layer and allowing the transport of these holes or electrons through the organic layer to selectively discharge the surface charge. The charge transport layer not only serves to transport holes or electrons, but also protects the photoconductive layer from abrasion or chemical attack. The charge transport layer should exhibit negligible, if any, discharge when exposed to a wavelength of light useful in xerography, e.g. 4000 Angstroms to 9000 Angstroms. The charge transport layer is normally transparent in a wavelength region in which the electrophotographic imaging member is to be used when exposure is effected therethrough to ensure that most of the incident radiation is utilized by the underlying charge generating layer. When used with a transparent substrate, imagewise exposure or erase may be accomplished through the substrate with all light passing through the substrate. In this case, the charge transport material need not transmit light in the wavelength region of use if the charge generating layer is sandwiched between the substrate and the charge transport layer. The charge transport layer in conjunction with the charge generating layer is an insulator to the extent that an electrostatic charge placed on the charge transport layer is not conducted in the absence of illumination. Charge transport layer materials are well known in the art.

The charge transport layer may comprise activating compounds or charge transport molecules dispersed in normally electrically inactive film forming polymeric materials. These charge transport molecules may be added to polymeric materials which are incapable of supporting the injection of photogenerated holes and incapable of allowing the transport of these holes. An especially preferred charge transport layer employed in multilayer photoconductors comprises from about 25 percent to about 75 percent by weight of at least one charge transporting aromatic amine, and about 75 percent to about 25 percent by weight of a polymeric film forming resin in which the aromatic amine is soluble. Examples of typical charge transporting aromatic amines include triphenylmethane, bis(4-diethylamine-2-methylphenyl)phenylmethane; 4′-4″-bis(diethylamino)-2″, 2-dimethyltriphenylmethane; N,N′-bis(alkylphenyl)-(1,1″-biphenyl)-4,4′-diamine wherein the alkyl is, for example, methyl, ethyl, propyl, n-butyl, etc.; N,N′-dipheny-N,N″-bis(3-methylphenyl)-(1,1″-biphenyl)-4,4″-diamine; and the like, dispersed in an inactive resin binder.

Any suitable inactive thermoplastic resin binder may be employed. Typical inactive resin binders include polycarbonate resins, polyvinylcarbazole, polyester, polyarylate, polyacrylate, polyether, polysulfone, and the like. Molecular weights can vary from about 20,000 to about 150,000.

The thickness of the charge transport layer may range from about 10 micrometers to about 50 micrometers, and preferably from about 20 micrometers to about 35 micrometers. Optimum thickness may range from about 23 micrometers to about 31 micrometers.

An optional conventional overcoating layer, if needed, may also be used. The optional overcoating layer may comprise organic polymers or inorganic polymers that are electrically insulating or slightly semi-conductive. The overcoating layer may range in thickness from about 2 micrometers to about 8 micrometers, and preferably from about 3 micrometers to about 6 micrometers to complete the material package and preparation procedures of the seamless photoreceptor belt.

It is important to point out that each of the above-mentioned photoreceptor coating layer may be applied by any suitable conventional technique such as spraying or solution dip coating. Sequential drying of each deposited coating layer shall be carried out to completion before application of the next subsequent layer. Drying may be effected by any suitable conventional technique such as oven drying, infra red radiation drying, air drying and the like.

For electrographic imaging member belt preparation utilizing the invention flexible thin profile seamed substrate support belt, a flexible dielectric layer overlying the conductive layer may be substituted for the photoconductive layers. Any suitable, conventional, flexible, electrically insulating dielectric thermoplastic polymer may be used in the dielectric layer of the electrographic imaging member.

If desired, the concept of the morphologically improved seam configuration of this invention may be extended to fabrication of any flexible belts having different material compositions where cycling durability is important.

For preparation of a flexible single layer intermediate image transfer belt, the two opposite ends of a rectangular or parallelogram cut sheet of between about 50 and 150 micrometers in thickness is subjected to the exact preceding described excimer laser ablation procedures prior to the overlapping and seam bonding process to form the invention imageable seamed intermediate image transport belt. Again, the seam bonding can be carried out through ultrasonic welding, gluing, stapling, or the like depending on the material and composition make up of the intermediate image transfer belt. For a typical intermediate image transfer belt design using polyimide, say duPont Kapton, seam overlap joining is formed by using a polyamide adhesive.

This invention will further be illustrated in the following, non-limiting examples, it being understood that these examples are intended to be illustrative only and that the invention is not intended to be limited to the materials, conditions, process parameters and the like recited therein.

### EXAMPLE I

A 3-mil (76.2 micrometers) thick biaxially oriented flexible poly (ethylene terephthalate) substrate support web (Melinex 442, available from ICI Americas, Inc.) was cut to provide eight 10.16 cm (4 in.)×10.16 cm (4 in.) rectangular shape substrate support samples and were then divided equally into four sets of two samples per set for fabrication into 2 morphologically different seam configurations, the typical prior art overlap seam and the thin profile invention seam, using ultrasonic seam welding process. The resulting seams obtained were then evaluated and compared for their respective physical/mechanical properties.

In the first set of two substrate support samples, one end of each substrate support sample had a vertical cut end (cut in a direction perpendicular to the upper surface of the substrate support sample). The vertical cut end of one substrate support sample was overlapped a distance of about 1.5 millimeters over the cut end of the other substrate support sample and joined by conventional ultrasonic welding techniques using 40 KHz sonic energy supplied to a welding horn to form a prior art overlapped welded seam control. The second set of two substrate support sample was again welded, in the same manner, to give a duplicate prior art overlapped seam control. These control prior art overlapped welded seams had an average seam thickness of about 172 percent the thickness of the substrate support.

For the third and fourth sets of substrate support samples, the ultrasonic seaming welding process was also employed, in the same manner as described, to give 2 thin profile invention welded seams, but with the exception that the excimer laser ablation processing step was utilized to shape alter the overlapping ends prior to the seam welding operation was carried out. In essence, the bottom surface of an edge of one substrate support sample and the top surface of an edge of the other substrate support sample were successfully shape altered using a masked KrF excimer laser, having an UV wavelength of 248 nm and a pulse frequency of 200 Hz, to produce a recess, by partially cutting into the edges through laser removal of material, rectangular-shaped profile identical to that shown in FIG. 5 when probed with a three-dimensional surface analyzer (Model T-4000, available from Hommel American, Inc.). The masked excimer laser ablation process, free of heat generation to cause substrate support sample distortion, enabled precise material removal with excellent accuracy at the edge of each sample to yield the desired sharp right angle profile and the desired seam thinning effect.

The resulting invention seams obtained after ultrasonic welding process have substantially nil added thickness and were also each subjected to slightly mechanical polishing step just to smooth out the mild surface texturing.

### EXAMPLE II

The ultrasonically welded seams of single layer substrate support of Example I were each evaluated for tensile seam rupture strength. For seam strength determination, the following testing procedures were followed using an Instron Tensile Tester (Model TM, available from Instron Corporation):

(a) Cut a strip of test sample from each of the seam designs from the above examples. Each test sample had the dimensions 1.27 cm×10.16 cm (0.5 in.×4 in.) with the seam situated at the middle and perpendicular to the long dimension of the test sample.

(b) Insert the test sample into the Instron jaws using a 5.08 cm (20 inch) gage length and position the seam at the center between the jaws.

(c) Pull the seam sample at a cross-head speed of 5.08 cm/minute (2 in./minute), a chart speed at 5.08 cm/minute (2 in./minute), at a calibration of 50 pounds (22 kilograms) full scale to tensile seam rupture.

(d) Divide the load, in pounds, required to rupture the seam by 0.5 in. to obtain the seam rupture strength in lbs/in.

The results obtained from the seam strength measurement showed that the control prior art seams had an average tensile seam rapture strength of about 49.7 lbs/in. was, by comparison, slightly higher than the 47.3 lbs/in. average seam strength value for the two thin profile invention seam counterparts. The slightly lower in seam rupture strength observed for the thin profile invention seam is, in practice, not important, since flexible imaging member belts fabricated by subsequent coating over with imaging layers onto the invention seamed substrate support belts, will be subjected to only a constant 0.18 kg/cm (1 lb./in.) width belt tension, which is about 47 times below its ultimate seam strength, as the belts function under actual machine operating conditions.

### EXAMPLE III

A control seamed flexible substrate support belt was prepared by ultrasonically welding the two opposite ends of a rectangular 353 mm×558 mm cut sheet of poly(ethylene terephthalate) by following the seam procedures described in Example I. A thin profile seamed flexible substrate support belt, having the invention seam design, again by the descriptions in Example I, was also prepared. These two substrate support belts were then each overcoated with various subsequent coating layers by dip coating process (completion of each coating was immediately followed by subsequent dying) to form flexible photoreceptor belts according to the procedures below: (1) each seamed substrate support belt was vacuum coated with a thin conducting, about 100 angstroms, aluminum layer, then applied over with a 1 micrometer thick 3-component charge blocking layer of polyvinyl butyral, zirconium acetyl acetonate, and gamma aminopropyl triethoxide silane then dried at elevated temperature; (2) after application of a 1,000 angstrom thick duPont 49000 polyester adhesive interface layer, a 0.2 micrometer charge generating layer consisting of 60% wt hydroxygallium phthalocyanine and 40% wt VMCH (available from Union Carbide) polymer binder was then applied; and (3) after drying the charge generating layer, a charge transport layer solution of 50% wt bis phenyl Z polycarbonate (available from Mitsubishi Chemicals) and 50% wt N,N″-diphenyl-N,N″-bis(3-methylphenyl)-(1, 1″-biphenyl)-4,4″-diamine in tetrahydrofuran was coated over and dried to give a 24 micrometer thick charge transport layer and thereby complete the material package of a flexible photoreceptor belt.

When cycling tested in an electrophotographic imaging machine, the flexible photoreceptor belt, fabricated using the substrate support belt having the invention thin profile seam, had virtually functioned like a seamless belt; it showed neither belt transport motion disturbance, nor cleaning blade mechanical interaction, and absolutely free of seam associated image printout problem in copy. In sharp contrast, the photoreceptor belt prepared with the prior art overlapped seamed substrate support counterpart not only gave seam image printout defect, the seam region was also physically an obstruction site to against the cleaning blade function; moreover, the seam region was also found to interact with all the machine belt module support rollers to affect belt motion quality because the seam thickness, in fact, acted like a speed bump to disrupt belt''s transport speed.

### EXAMPLE IV

Intermediate image transfer belts may be prepared by using polyaniline and carbon black loaded flexible polyimide (for example duPont Kapton) web. The polyimide web may be cut to any suitable rectangular or parallelogram shape and size and then subjected to the excimer laser ablation process (according to the process described in previous example) to give shape altered and overlapped thin seam morphology. A flexible imageable intermediate image transfer belt, having the invention thin seam profile, may then be obtained by overlapping the laser created ends and then glued together with a thin layer of conductive polyamide adhesive to yield a seam design as shown in FIG. 5 or 6. Since polyimide is not an ultrasonically weldable, neither solvent bondable, nor heat fuseable polymer film, a polyamide adhesive layer is need to bond the overlap into a seam.

Since the invention thin profile seam is prepared by overlapping a width of having a range of from about 0.8 to about 2.5 mm, the bonded area of the overlapping contact surface is therefore many times greater than the contacting area of the prior art puzzle-cut seam joint of a typical intermediate image transfer belt utilizing a 80 micrometers substrate thickness. Therefore, increasing the seam''s contacting bonded area increases the tensile seam rupture strength.

In recapitulation, there is provided a process for the preparation of a mechanically robust flexible single layer seamed substrate support belt having a seam that gives high tensile rupture strength, no added thickness, good material continuity, and physically as well as electrically functions as a virtually seamless substrate support belt; with this substrate support belt, the imaging member coating layers can be subsequently applied over by utilizing dip-coating or spray coating technique to form a flexible, multi-layered electrostatographic imaging member seamless belt. The obvious benefit of a seamless imaging member belt is that the entire belt surface is an imaging area, without the requirement of precision image registration to avoid image formation over the seam as in the case of the seamed imaging member belt counterpart.

Embodiments include a seamless flexible electrostatographic imaging member belt fabrication method comprising providing a flexible substrate support sheet, producing first desired features on a first portion of the substrate support sheet, including removing material from the substrate support sheet with first emissions, producing second desired features on a second portion of the substrate support sheet complementary to the first desired features, including removing material from the substrate support sheet with second emissions, overlapping the first and second desired features, bonding the first desired pattern with the second desired pattern to produce a seamed belt and applying at least one coating the substrate support sheet. Alternatively, embodiments can include a seamless flexible electrostatographic imaging member belt fabrication method comprising providing a flexible substrate support sheet, producing first desired features on a first portion of the substrate support sheet, including removing material from the substrate support sheet with first emissions, producing second desired features on a second portion of the substrate support sheet complementary to the first desired features, including removing material from the substrate support sheet with second emissions, removing material from the substrate with first and second emissions including inducing a desired shape in at least one of the first and second emissions by passing the at least one of the first and second emissions through at least one mask, removing material from the substrate with first emissions further including inducing relative motion between the laser beam and the substrate support sheet, overlapping the first and second desired features, bonding the first desired features with the second desired features to produce a substantially seamless belt, and applying at least one coating the substrate support sheet, the at least one coating including a photoconductive coating.

While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

1. A seamless flexible electrostatographic imaging member belt fabrication method comprising:
providing a flexible substrate support sheet;
placing a first pattern template on a first portion of the support sheet;
producing first desired features on the first portion of the substrate support sheet, including removing material from the substrate support sheet with first emissions, the first pattern template preventing the first emissions from striking the support sheet and thus preventing removal of material from under the first pattern template;
placing a second pattern template on a second portion of the support sheet, the second pattern template being complementary to the first pattern template;
producing second desired features on the second portion of the substrate support sheet complementary to the first desired features, including removing material from the substrate support sheet with second emissions, the second pattern template preventing the second emissions from striking the support sheet and thus preventing removal of material from under the second pattern template;
overlapping the first and second desired features;
bonding the first desired pattern with the second desired pattern to produce a seamed belt having substantially no added seam thickness; and
applying at least one coating over the seamed belt.

2. The method of claim 1 wherein removing material from the substrate support sheet with emissions includes inducing a desired shape in at least one of the first and second emissions by passing the at least one of the first and second emissions through at least one mask.

3. The method of claim 1 wherein at least one of the first and second emissions comprises electromagnetic radiation.

4. The method of claim 1 wherein at least one of the first and second emissions comprises a particle beam.

5. The method of claim 1 wherein removing material from the substrate support sheet with at least one of the first emissions and second emissions further comprises inducing relative motion between the at least one of the first emissions and second emissions and the substrate support sheet.

6. The method of claim 1 further comprising coating the seamed belt with a photoconductive material.

7. The method of claim 1 wherein bonding comprises ultrasonically welding.

8. The method of claim 1 wherein bonding comprises applying and curing an adhesive.

9. The method of claim 1 wherein the first and second templates are shaped to form a puzzle-cut pattern on the substrate support sheet.

10. A seamless flexible electrostatographic imaging member belt fabrication method comprising:
providing a flexible substrate support sheet;
placing a first pattern template on a first portion of the support sheet;
illuminating a first part of the substrate support sheet with a laser beam to produce first desired features on the substrate support sheet, including removing material from the substrate support sheet with first emissions, the first pattern template preventing the first emissions from striking the support sheet and thus preventing removal of material from under the first pattern template;
placing a second pattern template on a second portion of the substrate support sheet, the second pattern template being complementary to the first pattern template;
illuminating a second part of the substrate support sheet with a laser beam to produce second desired features on the substrate support sheet, including removing material from the substrate support sheet with second emissions, the second pattern template preventing the second emissions from striking the support sheet and thus preventing removal of material from under the second pattern template;
overlapping the first and second desired features;
bonding the first desired pattern with the second desired pattern to produce a seamed belt having substantially no added seam thickness: and
applying at least one coating over the seamed belt.

11. The method of fabricating a seamed flexible belt according to claim 10 wherein the illuminating a first part of the flexible substrate support sheet with a laser beam to produce first desired features on the substrate support sheet includes:
generating a laser beam;
spreading the laser beam;
illuminating at least one pattered mask such that parts of the spread laser beam pass through the mask as machining light; and
directing the machining light onto the first portion of the substrate support sheet and the first pattern template.

12. The method of fabricating a seamed flexible belt according to claim 10 wherein the first pattern template and the second pattern template induce complementary puzzle cut patterns in the respective first and second portions, and wherein the overlapping and bonding includes mating the puzzle-cut seams and subjecting the overlapped portions to ultrasonic welding.

13. The method of claim 10 wherein bonding includes applying and curing an adhesive.

14. The method of fabricating a seamed belt according to claim 12 wherein the first and second patterns form a rabbeted joint.

15. The method of fabricating a seamed belt according to claim 12 wherein the first and second patterns form a rabbeted joint.

16. A seamless flexible electrostatographic imaging member belt fabrication method comprising:
providing a flexible substrate support sheet;
placing first and second complementary pattern templates over first and second portions of the substrate support sheet;
bombarding the first portion of the substrate support sheet with first emissions to produce first desired features in a first pattern; bombarding the second portion of the substrate support sheet with second emissions to produce second desired features in a second pattern complementary to the first pattern;
mating the first and second desired features;
bonding the first desired features with the second desired features to produce a substantially seamless belt; and
applying at least one coating to the belt.

17. The method of claim 15 wherein bombarding a second portion includes bombarding an opposite surface of an opposite end of the substrate support sheet.

18. The method of claim 16 wherein applying at least one coating includes applying a photoconductive coating.

19. The method of claim 16 wherein providing a substrate support sheet comprises providing a single layer of substantially homogeneous material.

20. The method of claim 18 wherein providing a flexible substrate sheet further comprises providing a sheet of PET.

21. A seamless flexible electrostatographic imaging member belt fabrication method comprising:
providing a flexible substrate support sheet;
placing first and second pattern templates on respective first and second portions of the substrate support sheet:
producing first desired features on the first portion of the substrate support sheet, including removing material from the substrate support sheet with first emissions;
producing second desired features on the second portion of the substrate support sheet complementary to the first desired features, including removing material from the substrate support sheet with second emissions;
removing material from the substrate support sheet with first and second emissions including inducing a desired shape in at least one of the first and second emissions by passing the at least one of the first and second emissions through at least one mask;
removing material from the substrate with first emissions further including inducing relative motion between the laser beam and the substrate support sheet;
overlapping the first and second desired features;
bonding the first desired features with the second desired features to produce a substantially seamless belt; and
applying at least one coating the substrate support sheet, the at least one coating including a photoconductive coating.

22. The method of claim 20 wherein bonding comprises ultrasonically welding.

23. The method of claim 20 wherein bonding comprises applying and curing an adhesive.
